(19) United States
(12) Patent Application Publication
(10) Pub. No.: US 2006/0171103 A1
(43) Pub. Date: Aug. 3, 2006

(54) Frame part of installation casing

(75) Inventor: Matti Smalen, Klaukkala (FI)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB OY, Helsinki (FI)

(21) Appl. No.: 11/346,276

(22) Filed: Feb. 3, 2006

(30) Foreign Application Priority Data
Feb. 3, 2005 (FI) 20055049

(51) Int. Cl. H02B 1/00

(52) U.S. Cl. 361/600

(57) ABSTRACT

The invention relates to a frame part of an installation casing comprising: an installation panel for receiving equipment to be installed and a frame plate. In order to achieve a structure, in which the equipment installed in the installation casing can be protected from external vibration, a space between the installation panel and/or the frame plate is provided with protruding dents, and the installation panel and the frame plate are joined together by means of the dents.

### FIELD OF THE INVENTION

The present invention relates to a frame part of an installation casing, with the help of which any equipment installed in the installation casing can be protected from external vibration and impacts. In this application, the concept “installation casing” should be understood widely to cover installation casings or cabinets of different type and size, into which components to be protected from vibration can be arranged.

### DESCRIPTION OF THE PRIOR ART

Prior-art solutions exist, in which vibration protection for devices installed in an installation casing is provided by utilizing a layered structure. In such a case, a separate damping layer is arranged between an installation panel and frame plate. The damping layer is made of a material or designed in such a manner that it does not allow external vibration acting on the frame plate to transmit to the devices installed on the installation panel.

A weakness in the above-mentioned prior-art solution is, however, that it requires that a specific vibration-damping layer be made and installed in place. This causes extra material costs, manufacturing actions and installation work phases.

### SUMMARY OF THE INVENTION

It is an object of the present invention to provide for use a simpler solution than before, with which devices installed in an installation casing can be protected from external vibration. This object is achieved with the frame part of independent claim 1 and the method of independent claim 6.

For damping vibration, the invention utilizes dents formed in the installation panel or frame plate or both. The number, location, and shape of the dents affect the damping properties so as to provide exactly the right damping for the application.

According to the invention, the installation panel and frame plate comprise an angle, on both sides of which the installation panel and frame plate are fastened to each other through dents. In this embodiment, the structure becomes more rigid than before. In addition, one preferred embodiment uses perforation in the area of the dents to provide a structure that enables efficient cooling. In such a case, it is namely possible to provide an airflow in the space between the installation panel and frame plate on both sides of the above-mentioned angle.

Preferred embodiments of the frame part and method of the invention are disclosed in the attached dependent claims 2 to 5 and 7 to 8.

### BRIEF DESCRIPTION OF THE FIGURES

In the following, the invention will be described by way of example in greater detail with reference to the attached figures, in which

FIGS. 1 and 2 illustrate the assembly of a frame part of the invention, and

FIG. 3 shows a preferred embodiment of a frame part of the invention.

### DESCRIPTION OF A FEW EMBODIMENTS

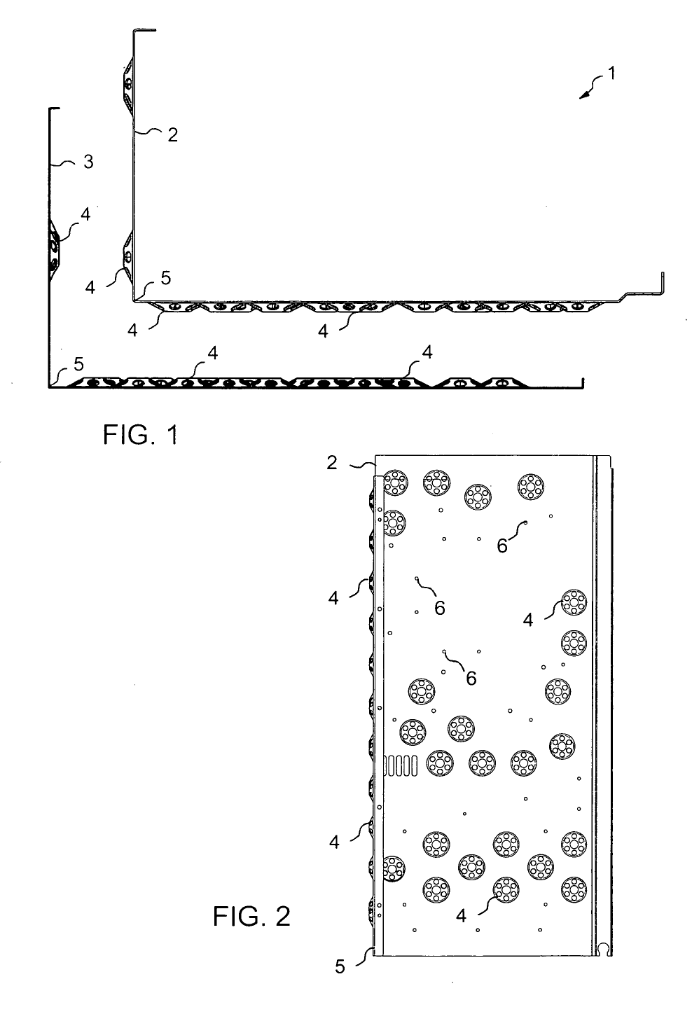

FIGS. 1 and 2 illustrate the assembly of a frame part of the invention. The frame part 1 is assembled from an installation panel 2 and a frame plate 3. FIG. 1 shows the installation panel 2 and frame plate 3 before they are attached to each other, and FIG. 2 shows the side of the installation panel 2 that faces the inside of the installation casing.

The metal installation panel 2 of the frame part 1 is made of an even plate in such a manner that the areas where dents will be formed are first perforated through the panel. After this, the dents 4 are formed into the panel by pressing. The dents 4 of the installation panel 2 are formed in such a manner that in a finished frame part, they protrude into the space between the installation panel 2 and frame plate 3. Finally, the installation panel 2 is bent to form an angle 5.

The metal frame plate 3 of the frame part 1 is made in the same manner as the installation panel. The dents in the frame plate 3 are formed in such a manner that in a finished frame part, they protrude into the space between the installation panel 2 and frame plate 3.

A finished frame plate 3 and installation panel 2 are set against each other in the position illustrated in FIG. 1. After this, the panel and plate are fastened to each other through the dents 4.

The figures show that the dents are mainly conical in shape, i.e. only their ends are flat where they come into contact with the opposite plate. Such dents can be formed in a plate by pressing.

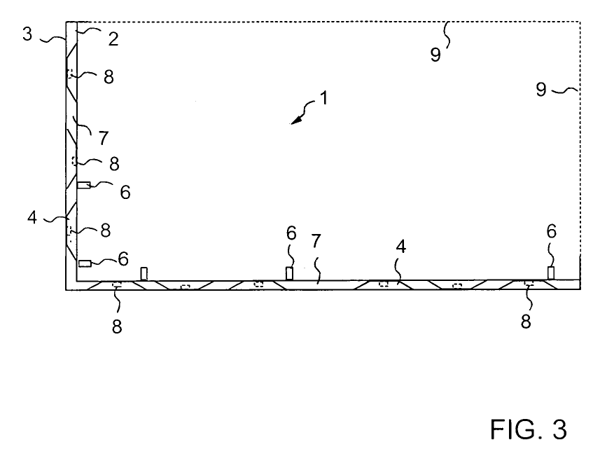

FIG. 3 shows a preferred embodiment of a frame part 1 of the invention. In the situation of FIG. 3, the frame plate 3 and installation panel 2 are fastened to each other at the dents. The fastening is preferably done by intangible riveting, in which a notch is hit through one of the plates with a sharp object so that the plate material displaced by the sharp object is pressed through the counterpart plate to form a rivet 8 between the plates.

Intangible riveting provides the advantage that the frame part 1 is inexpensive and quick to assemble and that for instance the corrosion risk caused by different material pairs can be avoided, because a separate rivet material is not necessary for the joining. However, the frame plate 3 and installation panel can also be attached to each other in some other manner, for example by screwing, welding, gluing, or by using a separate rivet.

In FIG. 3, the frame part 1 is shown installed in place into the installation casing shown from the top. The frame part 1 and the attached plates 9 thus form the walls of the installation casing that enclose the devices to be installed into the installation casing. The device to be installed are fastened to fastening pins 6 protruding from the installation panel 2. The frame plate 3 is fastened to the surrounding structure in such a manner, for instance, that it stands on the base of the installation casing. Because the installation panel 2 is fastened to the frame plate 3 through dents 4 only, vibration protection is achieved with the dents for the devices fastened to the fastening pints 6. The efficiency of the vibration protection depends on the shape and perforation of the dents and the thickness of the used plate.

In the example of FIG. 3, the dents 4 are staggered on the installation panel 2 and frame plate 3. An alternative is that the dents in the installation panel 2 and frame plate 3 are at the same locations, whereby the dents of different plates settle opposite each other in contact with each other. The distance between the installation panel 2 and frame plate 3 then doubles, and the space 7 becomes wider. This affects the vibration damping properties of the frame part 1 and the volume of air fitting into the space 7.

In FIGS. 1 and 2, the dents 4 are perforated. This is especially advantageous when devices requiring cooling are installed in the installation casing in question. The installation casing of a frequency converter is one example of a case in which efficient cooling is desirable. A fan can then be installed into the installation casing to provide airflow therein. The air can then flow through the perforations in the dents to the space 7 and out of the installation casing. In such a structure, the frame plate 3 forms the cooling element. By changing the size and location of the perforations, it is possible to affect the airflow. If necessary, filter material, for instance, can be mounted between the installation panel 2 and frame plate 3 during manufacturing, if the propagation of particles flowing in the airflow is to be restricted.

According to the invention, it is also possible that the dents are not perforated, if tightness, for instance, is more important in the application than efficient ventilation.

The figures show that there is an angle 5 in the installation panel 2 and frame plate 3 belonging to the frame part. This angle stiffens the frame part 1. In addition, it is advantageous for ventilation, because air ducts can then be made in the finished installation casing on two walls, i.e. on the leftmost wall and in the bottom wall in FIG. 3.

The embodiment shown by way of example in the figures thus makes it possible to provide efficient vibration damping and ventilation (cooling). In several applications, sufficient vibration damping can be achieved with the dents only, and other vibration damping structures are not necessary. According to the invention, it is, however, also possible to have another vibration damping structure in addition to the dents.

It is to be understood that the above description and the related figures are only intended to illustrate the present invention. Various variations and modifications of the invention will be apparent to a person skilled in the art without departing from the scope of protection of the invention.

1. A frame part of an installation casing, comprising:
an installation panel for receiving devices to be installed, and
a frame plate, and in which
the installation panel and/or the frame plate comprises dents which protrude into a space between the installation panel and frame plate,
the installation panel and frame plate comprise an angle,
the dents are arranged on both sides of the angle of the installation panel and frame plate, and
the installation panel and frame plate are fastened to each other through the dents on both sides of the angle of the installation panel and frame plate.

2. The frame part as claimed in claim 1, wherein the installation panel and frame plate are fastened to each other through the dents with intangible riveting.

3. The frame part as claimed in claim 1, wherein at least part of the area of the dents is perforated.

4. The frame part as claimed in claim 1, wherein
the installation panel and frame plate have dents settling against each other, and
the installation panel and frame plate are fastened to each other through the dents that settle against each other.

5. The frame part as claimed in claim 1, wherein the dents are mainly conical in shape.

6. A method for manufacturing a frame part of an installation casing, the method comprising
taking into use an installation panel and a frame plate,
selecting for shaping the installation panel or frame plate, or alternately both the installation panel and the frame plate, to form dents at predetermined locations in the selected plate,
bending the installation panel and frame plate to form an angle in the installation panel and frame plate so that there are dents on both sides of the angle,
setting the installation panel and frame plate to face each other in such a manner that the dents protrude into the space between the installation panel and frame plate, and
joining the installation panel and frame plate to each other through the dents.

7. The method as claimed in claim 6, wherein during the shaping, perforations are formed in the areas where the dents are made.

8. The method as claimed in claim 6, comprising joining the installation panel and frame plate to each other through the dents by using intangible riveting.
